(19) United States
(12) Patent Application Publication
(10) Pub. No.: US 2026/0196870 A1
(43) Pub. Date: Jul. 9, 2026

(54) SYSTEM AND METHOD FOR RADIO FREQUENCY ENERGY HARVESTING

(71) Applicant: POLYVALOR, LIMITED PARTNERSHIP, Québec (CA)

(72) Inventors: Yvon SAVARIA, Montreal (CA); Seyed Mohammad NOGHABAEI, Longueuil (CA); Rafael RADIN, Caen (FR); Mohamad SAWAN, Saint-Laurent (CA)

(21) Appl. No.: 19/134,312

(22) PCT Filed: Dec. 1, 2023
(86) PCT No.: PCT/CA2023/051603

§ 371 Date: May 30, 2025

Related U.S. Application Data
(60) Provisional application No. 63/429,525, filed on Dec. 1, 2022.

(51) Int. Cl. H02J 50/00; H02J 50/20; H02M 1/00; H02M 7/219

(52) U.S. Cl. CPC H02J 50/001; H02J 50/20; H02M 1/0067; H02M 7/219

(57) ABSTRACT

A method for operating a radio frequency energy harvester (RFEH) comprises, for each rectifier of the RFEH having connected thereto a switching device configured to be actuated between an open state in which an output of the rectifier is open-circuited to form part of a combined DC output voltage and a closed state in which the output of the rectifier is short-circuited to be omitted from the combined DC output voltage, measuring a voltage difference between the rectifier's input and output, comparing the voltage difference to a voltage threshold, when the voltage difference is below the voltage threshold, causing the switching device to be actuated to the closed state, and when the voltage difference is greater than or equal to the voltage threshold, causing the switching device to be actuated to the open state.

### CROSS-REFERENCE TO RELATED APPLICATIONS

The present application claims priority on U.S. Patent Application No. 63/429,525 filed Dec. 1, 2022, the entire contents of which are incorporated herein by reference.

### FIELD

The present disclosure generally relates to the field of radio frequency energy harvesting.

### BACKGROUND

The Internet of Things (IoT), in combination with artificial intelligence (AI), constitutes an emerging field of technology with numerous applications in everyday life, from smart cities and smart homes to on-body connected devices. For many of these applications, batteries are not a feasible solution, especially for wearable biomedical electronics and implementable devices, due to battery replacement challenges and the possibility of battery leakage. A promising solution for powering devices in the IoT environment is radio frequency (RF) energy harvesting, due to the widespread availability of RF signals near human settlements. A typical radio frequency energy harvester (RFEH) consists of an antenna, a matching network, and a rectifier. The antenna receives incident power (i.e., RF signals) and the matching network performs impedance matching between the antenna and the rectifier input to maximize power transfer from the antenna. The rectifier then converts the captured RF signals into a direct current (DC) output, which can in turn be stored in embedded storage devices for subsequent use.

Designing a low input voltage rectifier for RFEH is however challenging. The available ambient RF energy in free space is indeed limited and can only support portable electronic devices with very low-power consumption (e.g., from about 10-3 to about 10⁻⁶ W). In addition, the power density of the RF signals received at the RFEH's antenna is typically low due to propagation losses (from the RF energy source to the antenna), which can be aggravated by multi-path fading effects, and to limits imposed on RF power emission as a result of human health and safety regulations. Accordingly, there remains a need for improvement.

### SUMMARY

In accordance with one aspect, there is provided a radio frequency energy harvester comprising at least one antenna configured to receive, from a radio frequency (RF) energy source, RF signals in a plurality of frequency bands, and to convert the RF signals into alternating current (AC) voltage, a plurality of multi-stage rectifiers each configured to operate at a respective one of the plurality of frequency bands, each rectifier configured to receive the AC voltage from the at least one antenna and to convert the AC voltage to direct current (DC) voltage, and at least one power summation unit connected to the plurality of rectifiers and configured to generate a combined DC output voltage based on an output of the plurality of rectifiers, the at least one power summation unit comprising a plurality of switching devices, each respective switching device connected to a respective rectifier, each respective switching device configured to be actuated between an open state in which the output of the respective rectifier is open-circuited to form part of the combined DC output voltage and a closed state in which the output of the respective rectifier is short-circuited to be omitted from the combined DC output voltage, and a plurality of comparators, each respective comparator connected to the respective switching device and to the respective rectifier and configured to measure a voltage difference between an input and the output of the respective rectifier, compare the voltage difference to a voltage threshold, when the voltage difference is below the voltage threshold, cause the respective switching device to be actuated to the closed state, and when the voltage difference is greater than or equal to the voltage threshold, cause the respective switching device to be actuated to the open state.

In some embodiments, the at least one power summation unit further comprises transmission gates connected between the respective comparator and the respective switching device, and a pulse generator connected to the transmission gates, the pulse generator configured to, for each respective rectifier, monitor an elapsed time since the respective switching device was last brought to the open state, determine that the elapsed time is greater than or equal to a first predetermined time period, and output a pulse signal to the transmission gates to force the respective switching device to the open state for a second predetermined time period.

In some embodiments, the pulse generator comprises a multi-stage current-starved ring oscillator.

In some embodiments, each comparator is a hysteresis comparator.

In some embodiments, the radio frequency energy harvester further comprises at least one energy storage device configured to store the combined DC output voltage therein.

In some embodiments, the radio frequency energy harvester further comprises at least one matching network configured to perform impedance matching between the at least one antenna and the plurality of rectifiers.

In some embodiments, the at least one matching network comprises multiple matching networks having a differential L-network topology.

In some embodiments, the at least one matching network comprises multiple matching networks having a Pi-MN topology.

In some embodiments, the at least one matching network comprises a dual-band matching network.

In some embodiments, the at least one matching network comprises a wide-band matching network.

In some embodiments, the at least one antenna is configured to receive the RF signals at 850 MHz, 1900 MHz, and 2.4 GHz.

In some embodiments, the at least one antenna is a wide-band E-shape linear polarization antenna.

In some embodiments, the at least one antenna is wide-band circular polarization antenna.

In accordance with another aspect, there is provided a power summation unit for a radio frequency energy harvester (RFEH) comprising a plurality of rectifiers, each rectifier configured to convert radio frequency (RF) signals received at an antenna of the RFEH to direct current (DC) voltage, the power summation unit comprising a plurality of switching devices, each respective switching device connected to a respective rectifier, each respective switching device configured to be actuated between an open state in which an output of the respective rectifier is open-circuited to form part of a combined DC output voltage and a closed state in which the output of the respective rectifier is short-circuited to be omitted from the combined DC output voltage, and a plurality of comparators, each respective comparator connected to the respective switching device and to the respective rectifier and configured to measure a voltage difference between an input and the output of the respective rectifier, compare the voltage difference to a voltage threshold, when the voltage difference is below the voltage threshold, cause the respective switching device to be actuated to the closed state, and when the measured voltage is greater than or equal to the voltage threshold, cause the respective switching device to be actuated to the open state.

In some embodiments, the power summation unit further comprises transmission gates connected between the respective comparator and the respective switching device, and a pulse generator connected to the transmission gates, the pulse generator configured to, for each rectifier, monitor an elapsed time since the switching device was last brought to the open state, determine that the elapsed time is greater than or equal to a first predetermined time period, and output a pulse signal to the transmission gates to force the switching device to the open state for a second predetermined time period.

In some embodiments, the pulse generator comprises a multi-stage current-starved ring oscillator.

In some embodiments, each comparator is a hysteresis comparator.

In accordance with yet another aspect, there is provided a method for operating a radio frequency energy harvester (RFEH), the method comprising, for each rectifier of a plurality of multi-stage rectifiers of the RFEH, each rectifier configured to convert radio frequency (RF) signals received at an antenna of the RFEH to a direct current (DC) voltage, and each rectifier having a switching device connected thereto, the switching device configured to be actuated between an open state in which an output of the rectifier is open-circuited to form part of a combined DC output voltage and a closed state in which the output of the rectifier is short-circuited to be omitted from the combined DC output voltage, measuring a voltage difference between the input and the output of the rectifier, comparing the voltage difference to a voltage threshold, when the voltage difference is below the voltage threshold, causing the switching device to be actuated to the closed state, and when the voltage difference is greater than or equal to the voltage threshold, causing the switching device to be actuated to the open state.

In some embodiments, the method further comprises, for each rectifier, monitoring an elapsed time since the switching device was last brought to the open state, determining that the elapsed time is greater than or equal to a first predetermined time period, and forcing the switching device to the open state for a second predetermined time period.

In some embodiments, the method further comprises storing the combined DC output voltage in at least one energy storage device.

Many further features and combinations thereof concerning embodiments described herein will appear to those skilled in the art following a reading of the instant disclosure.

### DESCRIPTION OF THE FIGURES

In the figures,

FIG. 1A is a schematic diagram of a multiband radio frequency energy harvester (RFEH), in accordance with an illustrative embodiment;

FIG. 1B is a schematic diagram of a multiband RFEH, in accordance with another illustrative embodiment;

FIG. 2A is a circuit diagram detailing an L and a Pi matching network for the RFEH of FIG. 1A, in accordance with an illustrative embodiment;

FIG. 2B is a circuit diagram of a multistage self-compensated cross-coupled rectifier of the RFEH of FIG. 1A or FIG. 1B, in accordance with an illustrative embodiment;

FIGS. 3A, 3B, and 3C are plots illustrating post-layout results of the overall efficiency of the RFEH of FIG. 1A or FIG. 1B, and the output voltage of a five-stage RF-DC converter for different load resistor values and RF input power, in accordance with an illustrative embodiment;

FIG. 4A is a circuit diagram of the power summation unit of the RFEH of FIG. 1A or FIG. 1B, in accordance with an illustrative embodiment;

FIG. 4B is a circuit diagram of a pulse generator embedded in the RFEH of FIG. 1A or FIG. 1B, in accordance with an illustrative embodiment;

FIGS. 5A and 5B are plots illustrating simulation results of the power summation unit of FIG. 1A or FIG. 1B with a 1 kHz refresh rate, in accordance with an illustrative embodiment;

FIG. 6A is a schematic diagram of a broad-band E-Shape patch antenna for use with the RFEH of FIG. 1A or FIG. 1B, in accordance with an illustrative embodiment;

FIG. 6B is a schematic diagram of a circularly polarized patch antenna for use with the RFEH of FIG. 1A or FIG. 1B, in accordance with an illustrative embodiment;

FIGS. 7A to 7F are radiation patterns of the antennas of FIGS. 6A and 6B, in accordance with an illustrative embodiment;

FIG. 8 is a plot showing the simulated and measured reflection coefficient of the antennas of FIGS. 6A and 6B, in accordance with an illustrative embodiment;

FIG. 9 is a plot showing the simulated realized gain of the antennas of FIGS. 6A and 6B, in accordance with an illustrative embodiment;

FIG. 10 is an equivalent circuit of the prototype used for measurement of the RFEH of FIG. 1A or FIG. 1B, in accordance with an illustrative embodiment;

FIG. 11 is a plot of the measured overall efficiency of a five-stage RF-DC converter and an eight-stage RF-DC converter, for load resistor values of 450 kΩ and 1.5 MΩ, in accordance with an illustrative embodiment;

FIG. 12A is a plot of the measured overall efficiency of the RFEH of FIG. 1A using the power summation unit of FIG. 1A versus using a conventional diode-summation network when all frequencies are available, in accordance with an illustrative embodiment;

FIG. 12B is a plot of the measured overall efficiency of the RFEH of FIG. 1A using the power summation unit of FIG. 1A versus using a conventional diode-summation network when two frequencies are available, in accordance with an illustrative embodiment;

FIG. 12C is a plot of the measured overall efficiency of the RFEH of FIG. 1A using the power summation unit of FIG. 1A versus using a conventional diode-summation network when one frequency is available, in accordance with an illustrative embodiment;

FIG. 13 is a flowchart of a method for operating the RFEH of FIG. 1A or FIG. 1B, in accordance with an illustrative embodiment; and

FIG. 14 is a block diagram of an example computing device, in accordance with an illustrative embodiment.

It will be noticed that throughout the appended drawings, like features are identified by like reference numerals.

### DETAILED DESCRIPTION

Described herein is a multiband ultra-low-power (e.g., in the range between −20 dBm and −25 dBm) RF energy harvesting (RFEH) front-end for wearable devices and the Internet of things (IoT). In one embodiment, the proposed multiband RFEH may operate at GSM bands of 850 MHz and 1900 MHz, and 2.4 GHz WiFi. As will be described further below, the proposed multiband RFEH uses an automated power summation network to combine power from different frequency bands. First, a wideband antenna receives signals from various bands, which are boosted by respective matching networks. While a single antenna is described and illustrated herein, it should be understood that the RFEH may comprise more than one 180 antenna. For example, multiple antennas of same frequency, with beamforming, may apply. Three (3) self-compensated cross-coupled rectifiers optimized for harvesting different frequencies then enable conversion of the radio frequency (RF) signals provided by the three different frequency bands into DC output voltages. At the output of the rectifiers, a summation network using switching devices (referred to herein as switches) and a control circuit combinespower from different bands that contribute to charge an output capacitor. It should however be understood that any suitable number of frequencies (other than three (3)) may be harvested and the RFEH may therefore comprise any suitable number of components (e.g., any suitable number of rectifiers other than three (3)). In addition, and as will be described further below, multiple rectifiers may be combined to form a so-called “rectifier unit” and the RFEH may comprise multiple rectifier units whose outputs are fed as inputs to the power summation network.

In one embodiment and as will be discussed further below, measurement results have demonstrated a sensitivity of −31 dBm for 1 V output on a 100 MΩ load for a single 8-stage rectifier. As used herein, the term “sensitivity” refers to the minimum RF input from which energy can be harvested by the RFEH proposed herein to feed a load. In other words, sensitivity refers to the lowest RF input power that allows the RFEH to convert RF energy into DC output power. In one embodiment, an end-to-end peak (or highest) efficiency of 38% at −17 dBm when all frequency bands are available was also demonstrated. When two bands are available, a peak efficiency of the RFEH was demonstrated to be 44% at −17 dBm input power. When only one frequency is available, measurement results have confirmed a high peak efficiency of 41% at −16 dBm for the proposed power summation method (also referred to herein as “automated power summation”, APS, or AP-SUM), compared to 16% for conventional diode summation (also referred to herein as DS or “Diode-SUM”) in which diode-connected transistors are employed to perform summation of DC output power from rectifiers.

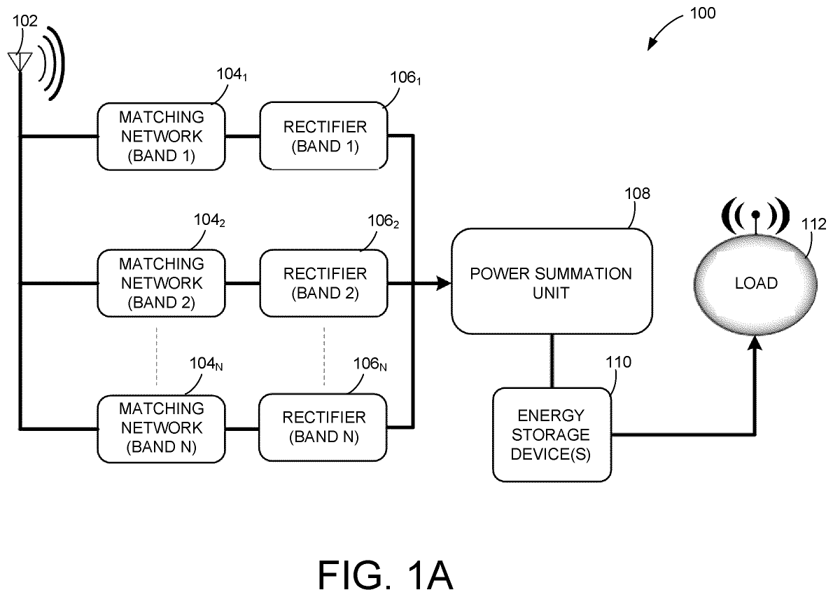

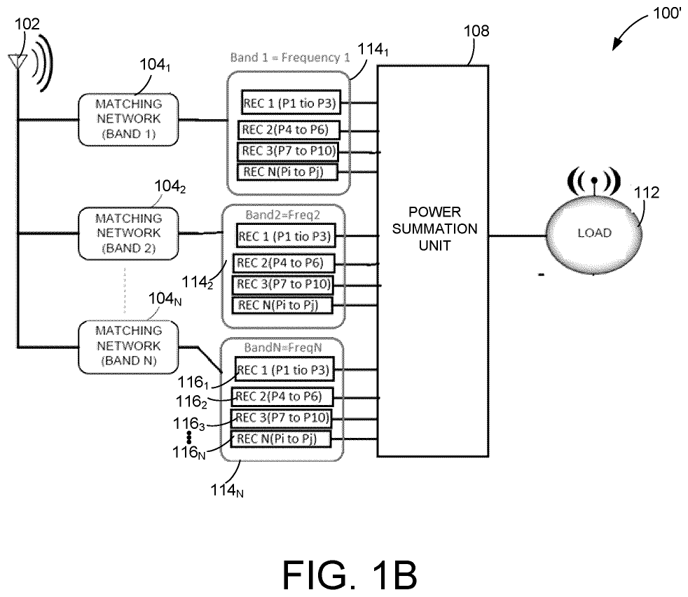

Referring now to FIG. 1A, a multiband RFEH 100 will now be described, in accordance with one embodiment. The RFEH 100 may be used to perform RF harvesting from multiband RF sources obtained with a dedicated power summation system, relying on advanced low power techniques. The RFEH 100 may exploit any suitable number of frequency bands. In one embodiment, the RFEH 100 exploits the following three frequency bands: 850 MHz, 1900 MHz, and 2.4 GHz. These represent frequencies that are the most available and which have the most significant power peaks among other available ambient frequencies. It should however be understood that any other suitable frequency band may apply, and any suitable number of frequency bands (other than three (3)) may also apply. The RFEH 100 may find use in a variety of applications including, but not limited to, battery-less systems such as IoT devices, wearable devices, wireless portable devices, wireless sensor networks (WSNs), and the like.

The RFEH 100 comprises a broadband receiving antenna 102 configured to receive ambient power (i.e. RF signals) having a plurality (N) of different frequency bands associated therewith (i.e. spanning different frequency bands), a plurality (N) of matching networks 104₁, 104₂, . . . , 104_{N}, and a plurality (N) of rectifiers 106₁, 106₂, . . . , 106_{N}, with each matching network 104₁, 104₂, . . . , 104_{N} being interposed between the receiving antenna 102 and its corresponding rectifier 106₁, 106₂, . . . , 106_{N}. The RFEH 100 exploits electromagnetic waves as a power source and behaves as an RF-DC converter by extracting power from radio waves transmitted by an RF energy source. In one embodiment, the RF energy source is a transmitting antenna (not shown) that transmits electromagnetic waves (i.e., RF signals) across a given distance to the receiving antenna 102 of the RFEH 100, which in turn captures (i.e., harvests) energy from the RF signals sent by the transmitting antenna. In particular, the receiving antenna 102 is configured to convert the RF signals into alternating current (AC) voltage. The matching networks 104₁, 104₂, . . . , 104_{N} perform impedance matching between the receiving antenna 102 and the rectifiers 106₁, 106₂, . . . , 106_{N} in order to improve the RFEH's overall power conversion efficiency, which is a measure of how efficiently the RF input power (harvested by the receiving antenna 102) is transformed into DC output power. The rectifiers 106₁, 106₂, . . . , 106_{N} receive incident power via the receiving antenna 102, with power transfer from the receiving antenna 102 to the rectifiers 106₁, 106₂, . . . , 106_{N} being maximized through the use of the matching networks 104₁, 104₂, . . . , 104_{N}. In particular, each matching network 104₁, 104₂, . . . , 104_{N} is configured to maximize power transfer from the antenna 102 to its respective rectifier 106₁, 106₂, . . . , 106_{N} by minimizing reflection losses and passively boosting the very low amplitude RF signals received.

In one embodiment, the number (N) of matching networks 104₁, 104₂, . . . , 104_{N} is the same as 240 the number of rectifiers 106₁, 106₂, . . . , 106_{N} and equals the number (N) of frequency bands.

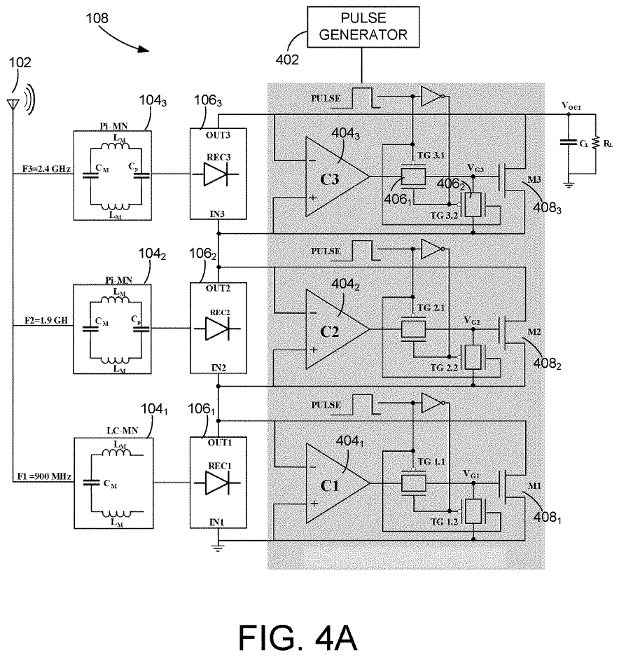

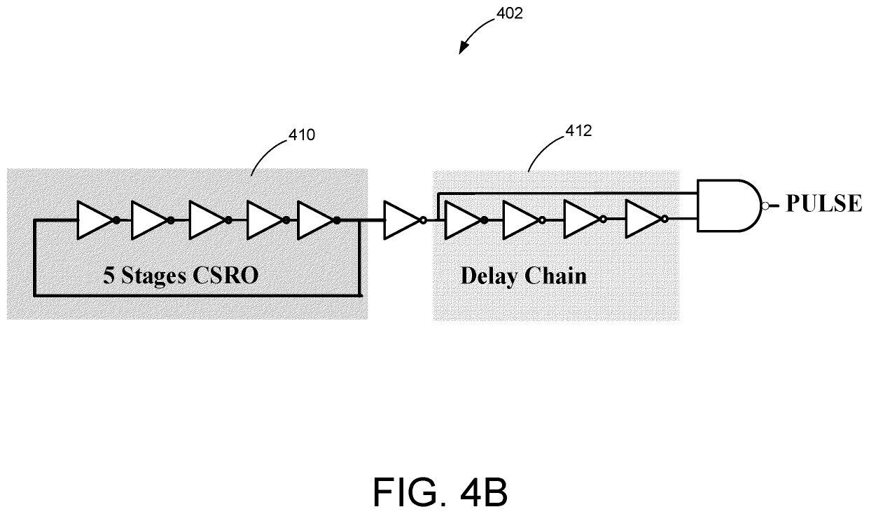

Each matching network 104₁, 104₂, . . . , 104_{N} (when multiple matching networks are used) and each rectifier 106₁, 106₂, . . . , 106_{N} is specific to (i.e., operates at) a given frequency band. In one embodiment (see FIG. 4A), the antenna 102 receives RF signals in three (3) frequency bands, such that the RFEH 100 comprises three (3) of the matching networks 104₁, 104₂, . . . , 104_{N} and three (3) of the rectifiers 106₁, 106₂, . . . , 106_{N} (i.e., N=3). The matching networks 104₁, 104₂, . . . , 104_{N} may be different or of the same type. It should also be understood that, while multiple matching networks as in 104₁, 104₂, . . . , 104_{N} are illustrated and described herein, a single matching network may be used. For example, in some embodiments, a dual-band matching network or a wide-band matching network may apply, depending on the frequency bands of the RF signals received at the antenna 102. In one embodiment, the rectifiers 106₁, 106₂, . . . 106_{N} are multi-stage self-compensated cross-coupled rectifiers designed using TSMC 65 nm Complementary Metal-Oxide-Semiconductor (CMOS) technology. In some embodiments, the matching networks 104₁, 104₂, . . . , 104_{N} may be provided off-chip.

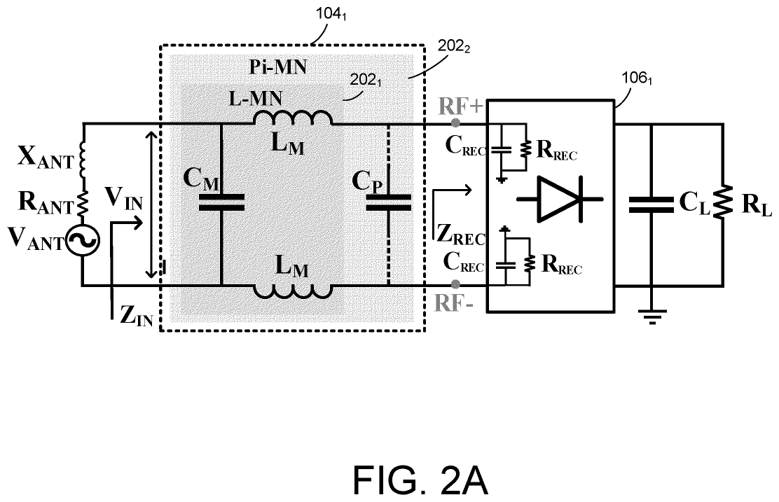

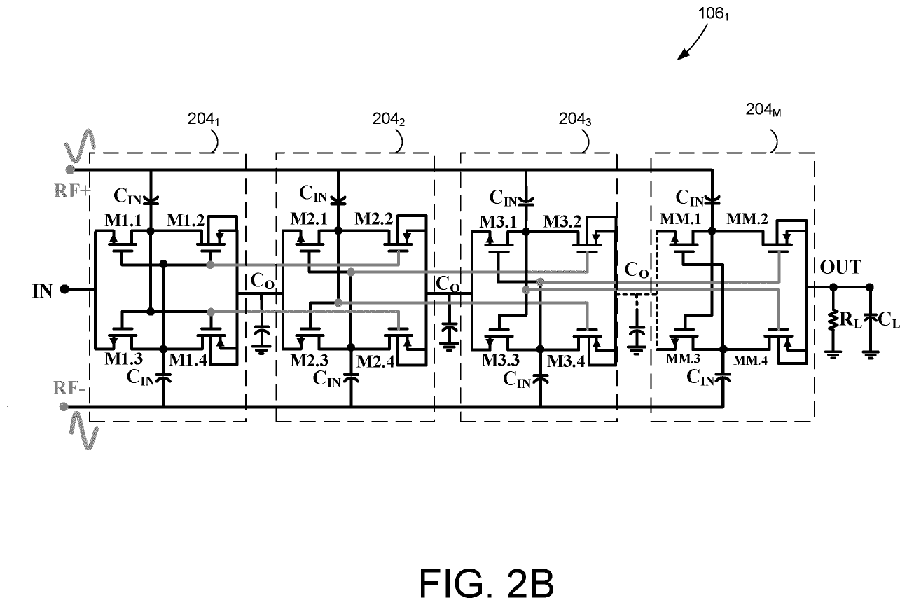

The RFEH 100 also comprises at least one power summation unit 108 configured to combine the DC output voltages of the rectifiers 106₁, 106₂, . . . , 106_{N}. Although reference is made herein to the RFEH 100 comprising a single power summation unit 108, it should be understood that more than one power summation 108 may be used, with each power summation unit 108 being configured to combine the output of a group of rectifiers as in 106₁, 106₂, . . . , 106_{N}. As will be described further below, the power summation unit 108 is configured to automatically control a plurality switches (not shown in FIG. 1A) embedded therein. The RFEH 100 further comprises one or more energy storage device(s) 110 for storing the harvested energy as DC voltage. In particular, the rectifiers 106₁, 106₂, . . . , 106_{N} each convert the incoming AC voltage (provided at input lines denoted RF+ and RF− in FIG. 2B) from their respective matching network 104₁, 104₂, . . . , 104_{N} to an output DC voltage that may be stored in one or more energy storage device(s) 110. The energy storage device(s) 110 include, but are not limited to, one or more supercapacitors or rechargeable batteries (such as lithium-ion batteries). The energy storage device(s) 110 may act as an energy reservoir maintaining operation when the RF power flux is unavailable, for instance when the distance between the RFEH 100 and the transmitting antenna (not shown) is above a threshold distance. The stored energy (i.e., the output DC voltage) may then be supplied to a load 112. In FIGS. 2A and 2B, the load 112 is represented using a resistive element R_{L} in parallel with a capacitive element C_{L}. In some embodiments, the capacitive element C_{L} may act as an energy storage and the resistive element R_{L} may represent current consumption of the load 112. It should be understood that any suitable load 112 may be used. In one embodiment, the load 112 comprises one or more IoT sensors. In other embodiments, the load 112 comprises one or more wearable devices. Other embodiments may apply.

Since the rectifier input impedance varies as a function of the frequency and the incident power (input power), the antenna impedance may vary as a function of the frequency. Therefore, in one embodiment, adapting impedances at a single frequency may prove more manageable than over an RF band (multiple frequencies). Moreover, due to the impedance variation, an RF band induces impedance mismatch and causes a decrease in the power conversion efficiency of the rectifier. In one embodiment, for a single band frequency, optimizing different rectifiers for different input power ranges and specific load resistance may increase the power conversion efficiency. This is shown in FIG. 1B, which illustrates a multiband RFEH 100′, in accordance with another embodiment. Similarly to the RFEH 100, the RFEH 100′ comprises a broadband receiving antenna 102 configured to receive ambient RF signals in a plurality (N) of different frequency bands and to convert the RF signals into AC voltage, a plurality (N) of matching networks 104₁, 104₂, . . . , 104_{N}, and a plurality (N) of rectifier units 1141, 114₂, . . . , 114_{N}, with each matching network 104₁, 104₂, . . . , 104_{N} being interposed between the receiving antenna 102 and its corresponding rectifier unit 1141, 114₂, . . . , 114_{N}. Each rectifier unit 1141, 114₂, . . . , or 114_{N} illustratively comprises a plurality (N) of individual rectifiers 116₁, 116₂, 116₃, . . . , 116_{N}. Each rectifier 116₁, 116₂, 116₃, . . . , 116_{N} receives incident power via the receiving antenna 102, with power transfer from the receiving antenna 102 to the rectifiers 116₁, 116₂, 116₃, . . . , 116_{N} being maximized through the use of the matching networks 104₁, 104₂, . . . , 104_{N}, and provides its output to power summation unit 108 which is configured to combine the DC output voltages of the rectifiers 116₁, 116₂, 116₃, . . . , 116_{N}.

Referring to FIG. 2A in addition to FIG. 1A, the matching network design and the rectifier design used in the RFEH 100 will now be described, in accordance with one embodiment. While FIG. 2A illustrates a single matching network 104₁ and a single rectifier 106₁, this is for illustrative purposes only and it should be understood that the description of the matching network 104₁ and rectifier 106₁ provided herein also applies to any one of the matching networks 104₂, . . . , 104_{N} and the rectifiers 106₂, . . . , 106_{N}. In addition, it should be understood that any suitable matching network design and rectifier design, such as the ones as described in co-pending U.S. Patent Application No. 63/393,078 filed on Jul. 28, 2022, the entire contents of which are incorporated herein by reference, may apply.

In one embodiment, two matching network (MN) designs may be used (as illustrated in FIG. 2A). First, an L-MN202₁ (implemented using a differential L-network topology comprising two inductors, not shown, having inductances L_{M}) may be used to operate at 850 MHz and 1900 MHz (i.e., GSM mobile). A Pi-MN 202₂ (comprising a capacitor having a capacitance Cp) may be used to operate at 2.4 GHz (i.e., WiFi). Using two matching network designs may allow to improve the sensitivity of the RFEH 100, while reducing reflections and improving power transfer from the RFEH 100 to the load 112, as well as matching the input impedance of the antenna 102 to the input impedance of the rectifiers (e.g., rectifier 106₁). In addition, the proposed matching network designs may also provide passive voltage boosting of the low-amplitude RF signals. Indeed, besides matching the input of the rectifier 106₁ with the receiving antenna 102, the matching network 104₁ may also perform passive voltage boosting of the AC signals from the receiving antenna 102, such signals (also referred to herein as “low-amplitude” signals) typically having an amplitude below a predetermined amplitude threshold. This is achieved by the matching network 104₁ introducing a boosting factor A_{V,boost}. Since the quality factor Q of the inductors of the matching network 104₁ (i.e. the ratio of each inductor's inductive reactance to its resistance at a given frequency) can limit the boosting factor A_{V,boost}, it is desirable to use inductors with the highest quality factor Q possible in order to maximize passive voltage boosting by limiting the losses in the matching network 104₁. Indeed, the higher the quality factor Q of the inductors, the closer the inductors approach the behavior of ideal inductors.

In order to validate the proposed matching network 104₁, S parameter analyses were performed based on post-layout models comprising parasitics extracted by Cadence. The models were partly elaborated with Ansys HFSS 2020nd considering the effects of printed circuit board (PCB)/package parasitics. Simulations were performed with ADS RF tools to optimize the values of the matching network components. Any suitable method may be used to optimize the L and Pi matching networks 202₁, 202₂. As shown in FIG. 2A, the receiving antenna 102 can be represented by a voltage source V_{ANT}, a series internal resistance R_{ANT} and a reactance X_{ANT}. The power available at the input of (i.e., harvested by or received at) the receiving antenna 102 is indicated as P_{AV}. For an ideal matching network 104₁, the amplitude of the RF signals received at the antenna 102 is given by:

$${V}_{ANT} = \sqrt{8 \times {R}_{ANT} \times {P}_{AV}} \qquad ( 1 )$$

The passive voltage boosting factor (also referred to herein as “matching network voltage gain”) A_{V,boost,L-MN} provided by the L matching network 202₁, is given by the following equation:

$$\begin{matrix}{A}_{V , boost , L - MN} & = \frac{{V}_{REC}}{\frac{{V}_{ANT}}{2}} = \sqrt{\frac{{R}_{REC}}{2 {R}_{ANT}}} = \frac{\sqrt{{Q}^{2} + 1}}{2} \\ & ≅ \frac{Q}{2} ( {R}_{REC} >> {R}_{ANT} )\end{matrix} \qquad ( 2 )$$

where V_{REC} is the rectifier input voltage and Q is the quality factor of the L matching network 202₁. In one embodiment, the quality factor Q depends on the resistance R_{ANT} of the receiving antenna 102 and on the load resistance 2R_{REC} of the rectifier 106₁. To improve the passive voltage boosting and to improve the sensitivity, it is desirable for R_{REC} to be maximized.

The passive voltage boosting factor A_{V,boost,Pi-MN} provided by the Pi matching network 202₂ is given by the following equation:

$${A}_{V , boost , Pi - MN} = ( 1 / {Z}_{IN} - 1 / {Z}_{CM} ) \times ( {Z}_{CP} ‖ {Z}_{REC} ) \qquad ( 3 )$$

where Z_{IN} is the matching network's equivalent input impedance, and Z_{REC} is the rectifier's equivalent input impedance. Z_{IN} is given by Z_{IN}=R_{IN}+jX_{IN}, with X_{IN} being the reactance of the matching network 202₂ and R_{IN} being the resistance of the Pi matching network 202₂.

A vital feature of the RFEH's RF-DC conversion chain is the RFEH's power conversion efficiency (PCE). However, in a RFEH such as the RFEH 100, due to propagation losses and multi-path fading effects, the RFEH's antenna 102 receives very low radio frequency power density. Therefore, designing a rectifier to efficiently convert low amplitude RF alternating current (AC) signals to DC voltage is challenging due to very low threshold voltage (V_{T}) of active devices, especially at ultra-low incident-power.

Referring now to FIG. 2B in addition to FIG. 1A and FIG. 2A, the proposed multi-stage rectifier design (e.g., for rectifier 106₁) will now be described. The proposed RF-DC power converter (i.e., RFEH 100) exploits both dynamic and static self-compensation schemes to reduce the threshold voltage of rectifying devices that can be used to harvest energy from multiple frequency bands. In one embodiment, the proposed rectifier may be adapted to better perform at lower input power, with the intention of achieving high sensitivity and maximizing the harvested power at low RF input power to improve the low-power limit.

The overall efficiency of the proposed RFEH can be defined as follows:

$$\begin{matrix}P C {E}_{RFEH - S} & = \frac{{P}_{OUT}}{{P}_{AV}} = P E {E}_{MN} \times P C {E}_{MN} \times P C {E}_{REC} \\ & = \frac{{V}_{OUT}^{2}}{{R}_{L} \times {P}_{AV}}\end{matrix} \qquad ( 4 )$$

where PCE_{RFEH-S} is the overall efficiency of the RFEH 100 including the matching network 104₁, and single rectifier 106₁, P_{AV} is the available input power, PEE_{MN} is the power extraction efficiency of the matching network 104₁, P_{reflected} is the reflection losses between the antenna 102 and the matching network 104₁, PCE_{MN} is the matching network's power conversion efficiency, and PCE_{REC} is the power conversion efficiency of the proposed rectifier 106₁.

In one embodiment, the power extraction efficiency of the matching network 104₁, can be defined as follows:

$$P E {E}_{MN} = \frac{{P}_{AV} - {P}_{{reflected}^{}}}{{P}_{AV}} \qquad ( 5 )$$

As illustrated in FIG. 2B, the proposed rectifier 106₁ comprises a plurality (M) of interconnected rectifier stages 204₁, 204₂, . . . , 204_{M}. In one embodiment, the rectifier 106₁, may comprise five (5) stages (i.e., M=5). In another embodiment, the rectifier 106₁, may comprise eight (8) stages (i.e., M=8). The number (M) of rectifier stages 204₁, 204₂, . . . , 204_{M} may vary depending on the application (e.g., on the input power range). Each stage 204₁, 204₂, . . . , 204_{M} of the rectifier 106₁, illustratively comprises a plurality of semiconductor devices (i.e., transistors) and a plurality of input coupling capacitors (labelled as C_{IN} in FIG. 2B). In some embodiments, the transistors are metal-oxide-semiconductor field-effect transistors (MOSFETs). In the embodiment illustrated in FIG. 2B, each stage 204₁, 204₂, . . . , 204_{M} of the rectifier 106₁ comprises four (4) transistors (labelled as M_{S,1}, M_{S,2}, M_{S,3}, and M_{S,4} for a given stage S, where S=1, . . . , M), of which two (2) are P-type metal-oxide-semiconductor (PMOS) transistors and two (2) are N-type metal-oxide-semiconductor (NMOS) transistors. In some embodiments, the rectifier 106₁ comprises NMOS transistors implemented with zero-V_{T} devices and PMOS transistors implemented with low-V_{T} devices.

In the illustrated embodiment, the rectifier 106₁ has a cross-coupled topology to compensate for the transistor threshold voltage (V_{T}). The rectifier 106₁ is self-compensated. Although the rectifier 106₁ is illustrated and described herein as having a cross-coupled topology, other topologies may apply, including, but not limited to, the Greinacher doubler (also known as the half-wave voltage doubler) topology and the Dickson topology. In the proposed cross-coupled topology, a dynamic bias voltage, which is in opposite phase to the signal being rectified, is applied to the control terminals (also referred to herein as the “gates”) of the rectifier's transistors. In other words, the signal being rectified is in counterphase with the signal applied to the gates of the transistors, compensating the effects of the transistors' threshold voltage (V_{T}), which is a variable that affects the performance of the rectifier 106₁, particularly at low input power levels. In this manner, conduction losses associated with the drop in the transistor's forward voltage (i.e. the amount of voltage needed to get current to flow across the transistor), and the losses associated with the transistor's reverse leakage current (i.e. the current from the transistor when the transistor is reverse biased) can be decreased, thus making the transistors more efficient in their on and off states. A static bias voltage may further be added to the dynamic bias voltage in order to increase the transistor drain current (Is_{EQ}), thus reducing the forward voltage drop across the transistors. The static compensation may further allow to reduce the widths of the transistors for a same drain current, thus reducing the overall silicon area occupied by the rectifier 106₁ on a chip and decreasing the input capacitance of the rectifier 106₁.

As illustrated in FIG. 2B, the proposed V_{T} compensation may be achieved by cross-connecting the gates of the transistors of a given rectifier stage 204₁, 204₂, . . . , 204_{M} using a signal from the previous rectifier stage 204₁, 204₂, . . . , 204_{M}, for all rectifier stages except the first stage 204₁ for which no previous stage is available for connection. In particular, the gate of a PMOS transistor in one stage 204₁, 204₂, . . . , 204_{M} of the rectifier 106₁ is connected to the opposite phase of the input signal into the previous stage 204₁, 204₂, . . . , 204_{M} of the rectifier 106₁.

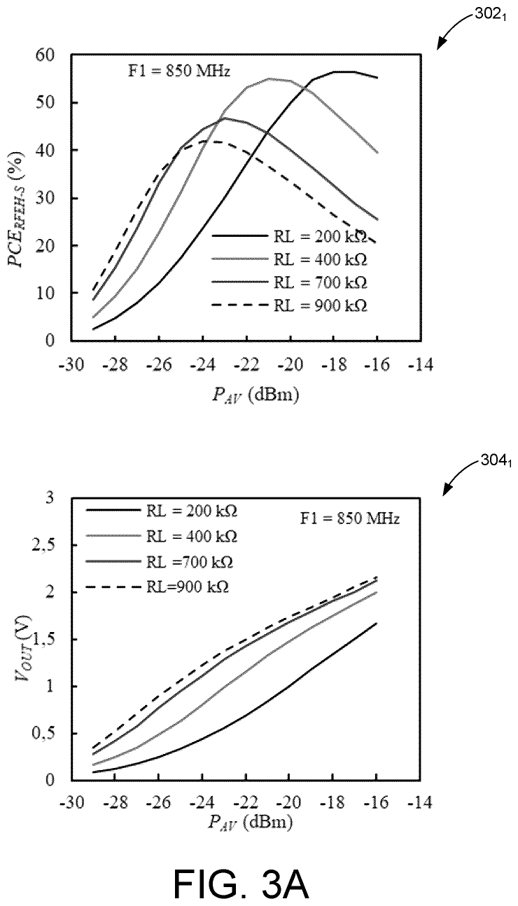

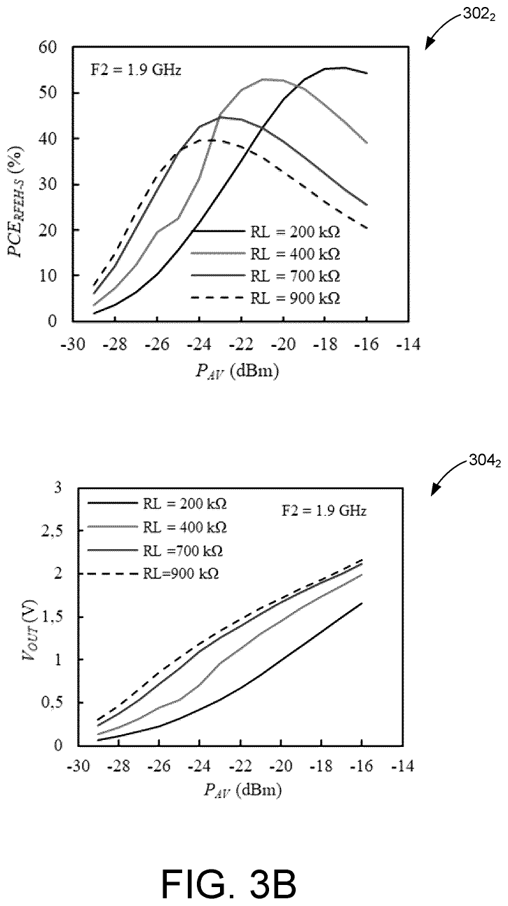

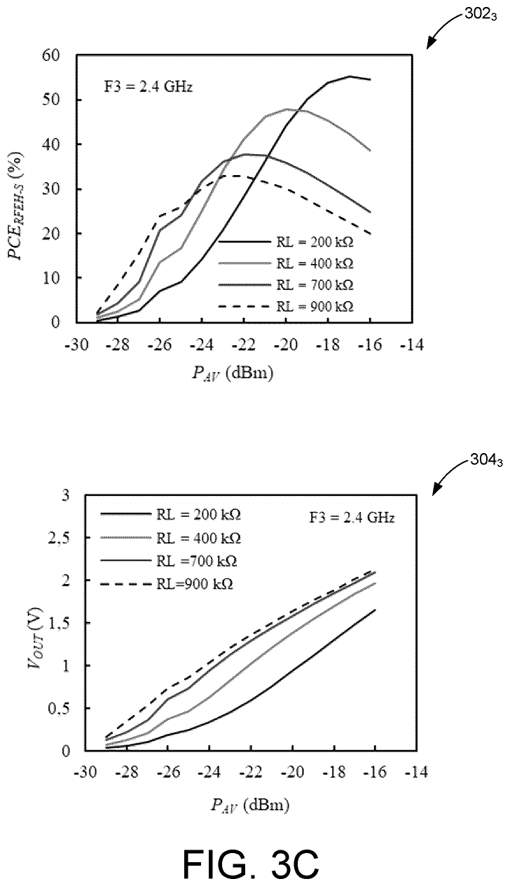

The proposed multi-stage rectifier structures may be optimized (e.g., using the optimization systems and methods as described in co-pending U.S. Patent Application No. 63/393,078 filed on Jul. 28, 2022, the entire contents of which are incorporated herein by reference) to improve sensitivity and to perform better at low RF input power levels with the different frequency bands of interest. The simulation results for different stages (5 and 8) are shown in FIGS. 3A, 3B, and 3C, excluding loss of the matching network (ideal MN). In particular, FIG. 3A illustrates a plot 302₁ showing post-layout results of PCE_{RFEH-S} and a plot 304₁ showing the output voltage of a five-stage RF-DC converter (or RFEH) at a frequency of 850 MHz, for different load resistor values (i.e. at 200 kΩ, 400 kΩ, 700 kΩ, and 900 kΩ) and RF input power (P_{A}V). FIG. 3B illustrates a plot 302₂ showing post-layout results of PCE_{RFEH-S} and a plot 304₂ showing the output voltage of the five-stage RF-DC converter (or RFEH) at a frequency of 1.9 GHz, for the different load resistor values and RF input power. FIG. 3C illustrates a plot 302₃ showing post-layout results of PCE_{RFEH-S} and a plot 304₃ showing the output voltage of the five-stage RF-DC converter (or RFEH) at a frequency of 2.4 GHz, for the different load resistor values and RF input power.

From FIGS. 3A, 3B, and 3C, it can be seen that, in one embodiment, the proposed design 425 achieves a peak efficiency (as per equation (4) above) of about 56% at −18 dBm and 850 MHz with a wide input power range of about 10 dB when PCE_{RFEH-S}>30%. This peak efficiency may be achieved by increasing the operational range of the rectifier 106₁ towards lower power levels. For this purpose, in some embodiments, RFEH optimization systems and methods as described in co-pending U.S. Patent Application No. 63/393,078 filed on Jul. 28, 202₂, the entire contents of which are incorporated herein by reference, may be used to increase the sensitivity of the RFEH at very low RF input power levels. Systems which are designed and optimized for maximum efficiency at higher levels of input power generally do not perform well at lower input power, typically due to internal leakages that make them unusable at very low RF input power levels. By contrast, if suitably designed, a system that works well at lower input power levels may also operate reasonably well at higher RF input power, although the peak efficiency may not be as high as that of systems optimized primarily for high power levels.

Referring now to FIG. 4A and FIG. 4B, the power summation unit (reference 108 in FIG. 1A) will now be described, in accordance with one embodiment. FIG. 4A details the components of the proposed power summation unit 108 of the multiband RFEH (reference 100 in FIG. 1A) while FIG. 4B illustrates a pulse generator 402 embedded in the proposed multiband RFEH 100 for use with the power summation unit 108.

Along with the challenges in single-source energy harvesters, one of the additional challenges for multiband energy harvesting is to combine the energy with minimum loss, in particular when combining energy from high frequency bands. To control the switches that perform the power summation (referred to herein as “summation switches”), it is proposed herein to use the power summation unit 108, which illustratively comprises the pulse generator 402 configured to generate a pulse (labelled “Pulse” in FIGS. 4A and 4B), a plurality of hysteretic comparators 404₁, 404₂, 404₃, . . . (three (3) of which are shown in FIG. 4A for sake of clarity), a plurality of pairs of transmission gates 406₁, 406₂, and a plurality of interconnected summation switches 408₁, 408₂, 408₃, . . . (three (3) of which are shown in FIG. 4A for clarity).

Each summation switch 408₁, 408₂, 408₃, . . . is connected between an input and an output of a corresponding rectifier 106₁, 106₂, . . . , 106_{N} and is configured to be actuated between an open state and a closed state. Each pair of transmission gates 406₁, 406₂ is connected between a respective comparator 404₁, 404₂, 404₃, . . . and summation switch 408₁, 408₂, 408₃, . . . , with the first transmission gate 406₁ being connected between the comparator's output and the switch's gate, and the second transmission gate 406₂ being connected between the rectifier's input and output. In one embodiment, the number (N) of hysteretic comparators 404₁, 404₂, 404₃, . . . is the same as the number (N) of summation switches 408₁, 408₂, 408₃, . . . and 460 equals the number (N) of matching networks 104₁, 104₂, . . . , 104_{N} and rectifiers 106₁, 106₂, . . . , 106_{N} of the RFEH 100. In one embodiment, each hysteretic comparator 404₁, 404₂, 404₃, . . . and each summation switch 408₁, 408₂, 408₃, . . . is connected to a first transmission gate 406, and a second transmission gate 406₂.

The main role of the power summation unit 108 is to keep the summation switches 408₁, 408₂, 408₃, . . . closed when RF frequency is unavailable and open when RF frequency is available.

In particular, for the i-th rectifier (e.g., rectifier 106₃), the power summation unit 108 ensures that the i-th summation switch (e.g., summation switch 408₃) remains closed when the i-th RF frequency, labelled Fi (e.g., F3=2.4 GHz), is unavailable and opened when the i-th RF frequency is available. The availability of the i-th RF frequency is determined by comparing the voltage levels at the input and output nodes (e.g., nodes IN3 and OUT3) of the rectifier (e.g., rectifier 106₃). In the proposed design, a difference of about 100 mV between the voltage level at the rectifier's output node and the voltage level at the rectifier's input node was considered as a threshold from (i.e., above) which the frequency band is assumed to be available. The comparison between the voltage levels at the input and output nodes is then made by the hysteretic comparators 404₁, 404₂, 404₃, . . . being designed with an intentional offset of around 100 mV. It should be understood that threshold values other than 100 mV may apply. For example, the voltage threshold may be set to 0 mV, 70 mV, or any other suitable value, depending on the application. The comparison result is then output by the hysteretic comparators 404₁, 404₂, 404₃, . . . and provided to the summation switches 408₁, 408₂, 408₃ (via transmission gates 406₁ and 406₂) to control the manner in which power from the different frequency bands is combined by the power summation unit 108.

In particular, the power summation unit 108 performs a smart summation of several rectifier DC voltages, selecting those that provide significant power and isolating (i.e., disregarding) DC voltages that do not provide significant power, to generate a combined DC output voltage. For this purpose, when the RF signal is unavailable (i.e. the difference between the voltage levels at the rectifier's input and output nodes is below the voltage threshold, as determined by a given comparator 404₁, 404₂, 404₃), the corresponding summation switch 408₁, 408₂, 408₃, . . . is brought to a closed (or “On”) state, such that the output of the corresponding rectifier 106₁, 106₂, . . . , 106_{N} is short-circuited by the summation switch 408₁, 408₂, 408₃, . . . . The output voltage of the short-circuited rectifier 106₁, 106₂, . . . , 106_{N} is therefore not considered in the power summation performed by the power summation unit 108, i.e., the short-circuited rectifier's output voltage is disregarded in the summation of rectifier DC voltages and does not form part of (i.e., is removed or omitted from) the combined DC output voltage. When the signal is available (i.e., the difference between the voltage levels at the rectifier's input and output nodes is greater than or equal to the voltage threshold, as determined by a given comparator 404₁, 404₂, 404₃), the corresponding summation switch 408₁, 408₂, 408₃, . . . is brought to an open (or “Off”) state. As a result, the output of the corresponding rectifier 106₁, 106₂, . . . , 106_{N} is open-circuited by the summation switch 408₁, 408₂, 408₃, . . . . The output voltage of the rectifier 106₁, 106₂, . . . , 106_{N} is therefore considered in the power summation performed by the power summation unit 108, i.e., the open-circuited rectifier's output voltage is considered in the summation performed by the power summation unit 108 and forms part of the combined DC output voltage. A resulting output voltage (V_{OUT}) is then generated as a function of the state (open or closed) of the summation switches 408₁, 408₂, 408₃, . . . (and of the result of the power summation) and provided to the load 112 represented with resistive element R_{L} in parallel with capacitive element C_{L}.

A control circuit, formed by the transmission gates 406₁, 406₂, periodically forces the summation switches 408₁, 408₂, 408₃ to an open state in order to refresh the measurement of the DC voltage from each rectifier 106₁, 106₂, . . . , 106_{N}. This control circuit is piloted by the pulse generator 402, which generates a pulse signal (“Pulse”). The pulse signal is connected to the transmission gates 406₁, 406₂, . . . to periodically open the summation switches 408₁, 408₂, 408₃ for a predetermined time period (e.g., a few microseconds). The refresh rate of the pulse generator 402 corresponds to the period of time that has to elapse before the summation switches 408₁, 408₂, 408₃ are re-opened for the rectifier's output to be measured. While a refresh rate of 1 kHz is described herein, it should be understood that any suitable refresh rate may apply. In some embodiments, the pulse generator 402 may be configured to monitor the elapsed time since the summation switches 408₁, 408₂, 408₃ were last opened (to refresh the rectifier output measurement). If the elapsed time is greater than or equal to a predetermined time period (i.e., the refresh time based on the refresh rate has elapsed), the pulse generator 402 causes the pulse signal to be output in order to temporarily enforce the summation switches 408₁, 408₂, 408₃ to the open state. Once the switches 408₁, 408₂, 408₃ are in open state, the output voltage of individual rectifiers can be measured and compared with a predefined reference voltage to verify the existence of RF signals in the given frequency band. If the output voltage is higher than the reference voltage, the switch 408₁, 408₂, or 408₃ remains open after the end of the pulse, whereas if the output voltage is lower than the reference voltage, the switch 408₁, 408₂, or 408₃ is closed.

As illustrated in FIG. 4B, in one embodiment, the pulse generator 402 is a deeply current-starved ring oscillator (CSRO). In this embodiment, the combinational circuit of the pulse generator 402 comprises a multi-stage CSRO 410 and a delay chain 412. The delay chain 412 comprises several successive delay stages, with the output of the last stage being fed back to the first input stage. For example, the multi-stage CSRO 410 may comprise five (5) successive stages. As understood by those skilled in the art, the CSRO is a voltage-controlled oscillator (VCO) that plays an integral part in phase-locked loops, clock recovery circuits, frequency synthesizers, and almost all digital and analog systems. A current-starved ring VCO uses variable bias currents to control its oscillation frequency. As such, one can design the CSRO with low power consumption and a wide frequency range of operation. Any other embodiment may apply. For example, the pulse generator 402 may comprise, but is not limited to, logic gates, a relaxation oscillator, and the like.

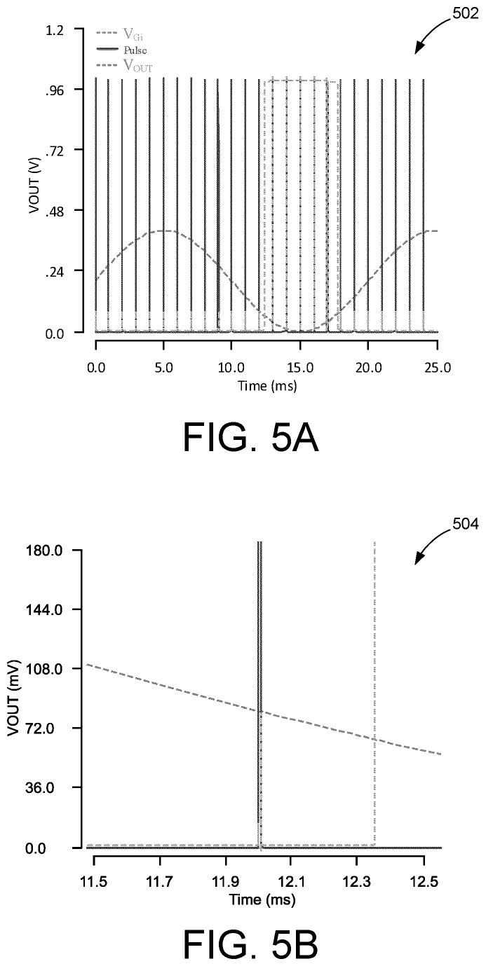

FIG. 5A shows a plot 502 of simulation results of the power summation unit 108 with a 1 kHz refresh rate. FIG. 5B shows a plot 504 that is a detailed version of plot 502, for a given measuring time period. As can be seen from FIGS. 5A and 5B, for an output voltage lower than the voltage threshold (e.g., 100 mV), a given summation switch (reference 408₁, 408₂, 408₃, . . . in FIG. 4A) is initially closed, and the pulse signal periodically opens the summation switch to perform measurements. When the difference between the rectifier's input and output voltages is greater than the voltage threshold, the summation switch changes is brought to its open state, allowing power summation at the RFEH's output. Due to the hysteretic nature of the comparators (reference 404₁, 404₂, 404₃, . . . in FIG. 4A), the power summation unit 108 closes the given summation switch only when the output voltage of the rectifier stage is lower than the voltage threshold. In one embodiment, the summation switches may be optimized to minimize the sum of conduction and leakage losses.

Referring back to FIG. 1A, any suitable antenna that is compact, of small size, and implantable (e.g., for biomedical applications) may be used for the receiving antenna 102. Designing a high gain antenna for far-field RF energy harvesting applications can however prove challenging. Antennas can be either on-chip or off-chip, with a single frequency or multiple frequency bands, and can simultaneously harvest energy from a single or multiple sources. Conventional antennas can be implemented on PCBs and the active circuits can be integrated on bounded wires connected to integrated circuits (ICs). By contrast, on-chip antennas can be used in implantable medical devices. However, the size of the antenna is a concern for fully integrated devices. Thus, there is a trade-off between the size and gain of the antennas since the effective aperture area of an antenna is proportional to its gain and, by reducing the size of the antenna, less power can be harvested. From Friss transmission equation (see equation (6) below), the amount of harvested energy depends on the transmitted power, the wavelength of the RF signals, the distance (R) between the RF energy source of the transmitting antenna and the receiving antenna 102 used as harvester unit. The relationship between the received power Pᵣ and transmitted power Pₜ with the distance of R is as follows,

$${P}_{AV} = {P}_{r} = {P}_{t} \cdot {G}_{t} \cdot {{G}_{r} ( \frac{λ}{4 π R} )}^{2} . \qquad ( 6 )$$

where P_{AV} is the power available at the input of (i.e., harvested by or received at) the receiving antenna 102, Gₜ and Gᵣ are the received and transmitted antenna gain, respectively, and A is the free space wavelength emitted from the transmitting antenna. Therefore, designing a high gain antenna can be a solution to increase the sensitivity by receiving a higher input signal.

It is desired to design the antenna 102 as a high gain and broadband antenna for the multiband RFEH 100, in order to increase the number of frequency bands from which energy can be harvested. A high gain antenna increases the sensitivity and efficiency of the RFEH 100, and with a wideband antenna, one can harvest from more frequency bands in a RFEH better suited for multiband applications. Thus, two different antenna design methodologies, namely a wideband E-Shape linear polarization antenna and a wideband circular polarization (CP) antenna, are proposed herein.

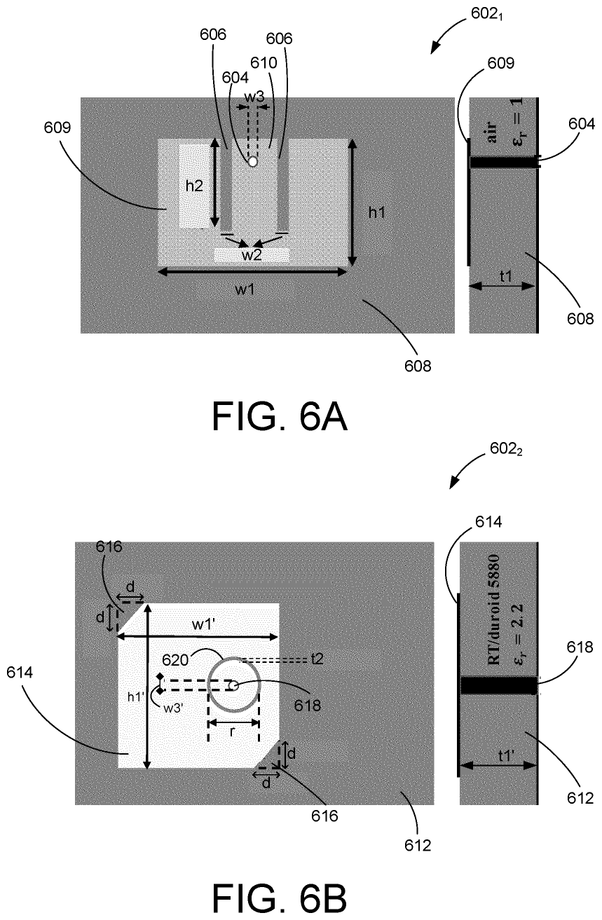

FIG. 6A illustrates the geometry of the proposed wideband E-Shape linear polarization patch antenna 602₁, in accordance with one embodiment. In one embodiment, the E-Shape patch antenna 602₁ comprises a probe feed 604, a pair of wide slots 606 (which are substantially equal slots and form the E-Shape), and a grounded air dielectric 608 designed for 2.4 GHz operation. In the illustrated embodiment, the E-Shape patch antenna 602₁ comprises a substantially rectangular patch 609 (which is disposed on the dielectric 608) that has a width w1 and a height h1. The length d1 of the center 610 between the slots 606 is adjustable as needed. Patch antennas that use air have wider bandwidths but with less performance when excited by a probe. There is a large inductance caused by a long probe which limits the impedance bandwidth. However, the slots 606 can minimize the reactance by introducing capacitances that can tune the impedance by changing the magnitude of the reactive components. Therefore, it is desirable for the dimensions (i.e., the height h2 and the width w2) of the slots 606 to be carefully designed to obtain desirable broadband performance. In one example, an E-Shape patch antenna 602₁ having a width w1 of 80.72 mm, and a height h1 of 49.16 mm, with slots having a width w2 of 4.37 mm and a height h2 of 36.08 mm, is used. In this example, the probe feed 604 has a width w3 of 1.3 mm and the dielectric 608 has a thickness t1 of 12 mm. Other embodiments may apply.

FIG. 6B illustrates the proposed geometry of the CP antenna 602₂, in accordance with one embodiment. The wideband CP antenna 602₂ is designed for improved performance at 2.4 GHz. In the illustrated embodiment, the CP antenna 602₂ uses a dielectric 612 (e.g., a Rogers 5880 dielectric) having a thickness t1′. The CP antenna 602₂ comprises a substantially square antenna patch 614 (which is disposed on the dielectric 612) that has a width w1′ and a height h1′ and comprises four (4) corners as in 616. The CP antenna 602₂ further comprises a probe feed 618 having a width w3′. In the proposed CP antenna 602₂, circular polarization is obtained by truncating (by a distance d) two opposite corners 616 on the antenna patch 614 in order to excite two degenerate orthogonal modes. In particular, circular polarization can be achieved for a square patch as in 614 by adjusting the two opposite corners 616 to obtain quadrature-phase coupling between the orthogonal propagation modes TM01 and TM10. Besides, using a thick substrate (i.e., the dielectric 612), a wideband performance can be achieved. Nevertheless, due to the inductance of the probe (not shown) feeding the antenna as in 602₂, there is a limit to increasing the substrate thickness t1′. To obtain wideband performance, a series capacitance (not shown) is used to compensate the inductance, which results in the wideband performance. In particular, by etching in the antenna patch 614 a circular slot centered on the probe feed 618, a capacitive disc 620 of radius r is created. In one embodiment, the patch 614 is fed by a 50Ω coaxial cable through the substrate 612. In one example, a CP antenna 602₂ having a width w1′ and a height h1′ of 37.29 mm, with the two opposite corners 616 truncated by a distance d of 7.3 mm, is used. The capacitive disc 620 illustratively has a radius r of 12.2 mm and a thickness t2 of 0.565 mm. In this example, the probe feed 618 has a width w3′ of 1.3 mm and the dielectric 612 has a thickness t1′ of 6.3 mm. Other embodiments may apply.

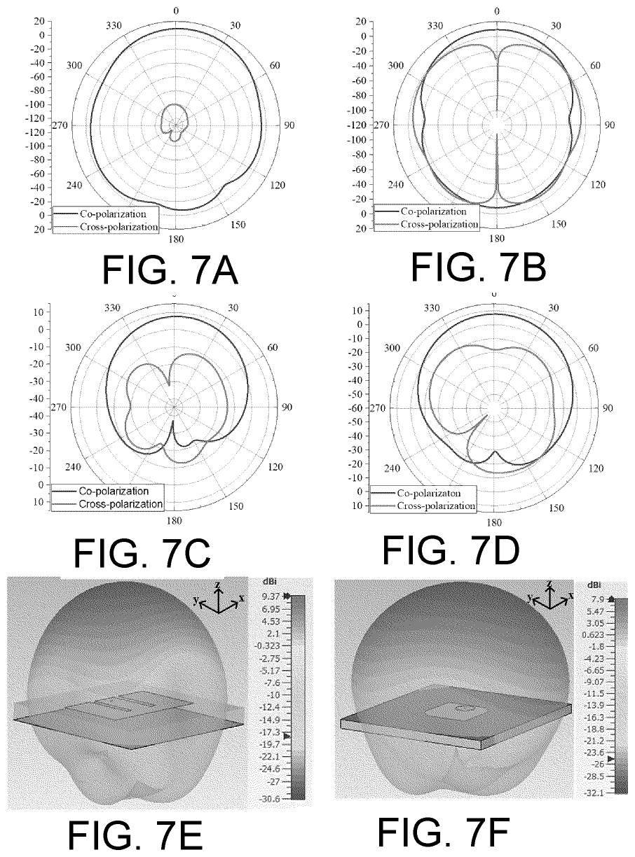

In order to validate the proposed antennas, the antennas were both designed and simulated using CST studio Suite 2020. The radiation pattern of both antennas is illustrated in FIGS. 7A, 7B, 7C, 7D, 7E, and 7F and demonstrates a directional pattern in both E- and H-planes (0=0⁰ and 90°). The co- and cross-polarization of the E-shape antenna at 2.45 GHz is reported in FIG. 7A for φ=90° and in FIG. 7B for φ=0°. The co- and cross-polarization of the CP antenna is reported in FIG. 7C for φ=90° and in FIG. 7D for φ=0°. FIG. 7E shows the three-dimensional (3D) radiation pattern of the proposed E-shape antenna at 2.45 GHz, and FIG. 7F shows the 3D radiation pattern of the proposed CP antenna at 2.45 GHz. In FIG. 7A, the cross-polarization in H-plane patterns is small and less than E-plane patterns. However, relatively large cross-polarization radiation (see FIG. 7B) is obtained due to the large substrate thickness and long feed-pin in the dielectric layer. On the other hand, for both φ=0⁰ and 0=90°, the difference between the co- and cross-polarization levels along the bore-sight direction is about 22 dB (see FIGS. 7C and 7D). Consequently, Right Hand Circular Polarization (RHCP) radiation at broadside is obtained for the CP antenna (see FIGS. 7C and 7D). With the E-shape antenna, for all angles other than 0°, the pattern is asymmetrical. In other words, the E-shape antenna has a single broadside lobe that is symmetric in the E-plane for 0° and asymmetric in the rest of the plane. Assuming that the transmitter is a portable device with random orientation (vertical or horizontal), the CP antenna may prove a better choice to prevent a polarization mismatch. In other words, in a CP antenna, the receiver's polarization does not need to be aligned with the polarization of the transmitter.

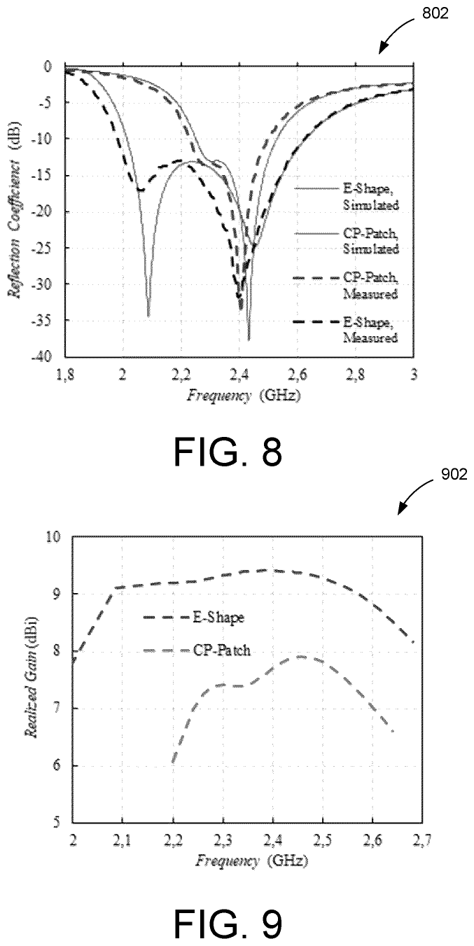

The simulated and measured reflection coefficient (S11) of the CP and E-shape antennas are presented in the plot 802 of FIG. 8. Both antennas exhibit a broadband impedance bandwidth. There is also an agreement between the simulation and the measurement. For example, from the simulation, the E-shape antenna features a bandwidth of around 613 MHz from 2.014 GHz to 2.627 GHz. By contrast, the CP antenna offers a bandwidth of 279 MHz from 2.251 GHz to 2.53 GHz. Thus, the E-shape and CP antennas exhibit impedance bandwidths as large as 26%, and 12% of their center frequency, respectively.

The simulated gain of both antennas for frequencies within the impedance bandwidth is presented in the plot 902 of FIG. 9. The maximum realized gain for E-shape and CP antenna at 2.45 GHz is around 9.37 dBi and 7.9 dBi, respectively (see FIG. 9 and FIGS. 7E and 7F). Although achieving a high radiation gain in circular polarization is challenging, the proposed CP antenna shows a high gain within a broadband impedance bandwidth, which makes it suitable for RFEH applications.

In order to validate the proposed multiband RFEH 100, the latter was designed and implemented in TSMC 65 nm standard CMOS process. In one embodiment, the chip prototype was designed to comprise two different power summation implementations and two different RF-DC converters (or RFEHs) comprising five (5) and eight (8) stages, which were optimized for three (3) different frequencies and low power applications. The die size was 0.7 mm×1.4 mm, while the effective area of the five-stage and eight-stage rectifiers were 61 μm×76 μm and 61 μm×100 μm, respectively. In addition, two different implementations comprising three rectifiers with two different number of stages (five (5) and eight (8)) implemented using two different power summation schemes, including the proposed summation and conventional diode summation, were designed and tested.

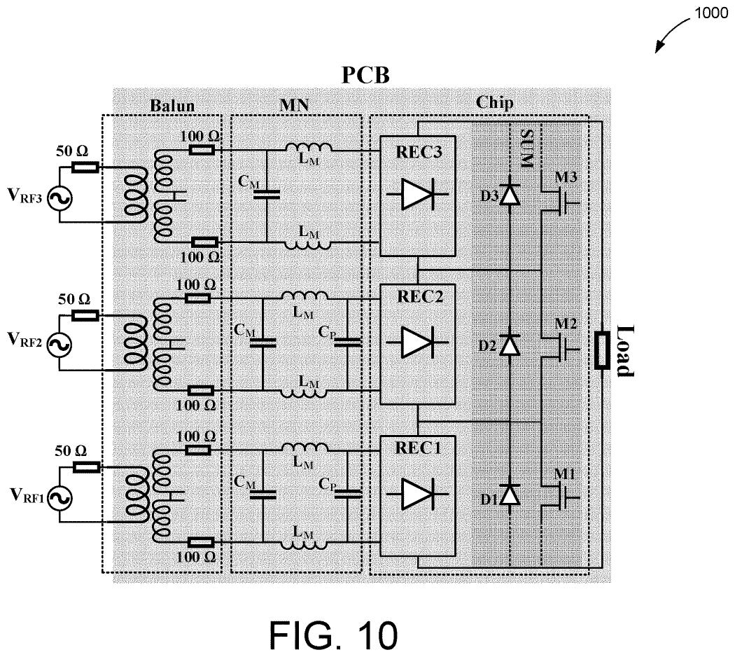

The equivalent circuit 1000 of the proposed multiband harvester with the two different power summation solutions (i.e., the proposed power summation method and the conventional diode summation method) is presented in FIG. 10. Unwanted parasitic components affect the circuit's performance, especially at higher frequencies. Therefore, the PCB prototype of the proposed RFEH 100 was designed with a low-loss material (e.g., Duroid 5880) to minimize energy losses and parasitic component values through careful layout, packaging, and wire bonding. The measurement setup illustratively comprised two RF signal generators (e.g., Keysight ESG-3000A and E4438C) with 50Ω output impedance, two network analyzers as RF generators (e.g., Agilent 8722ES) and Vector Network Analyzer (VNA) (e.g., Keysight E5071C), and an oscilloscope (e.g., Keysight DSA91304A). A balun was used to simulate differential signals while measuring, with the oscilloscope being used to visualize the correct functioning of the balun utilized for conversion between unbalanced and balanced signals. The oscilloscope was also used for measuring the output voltage in some experiments. However, the oscilloscope was disconnected from the RF inputs when measuring the efficiency of the rectifier.

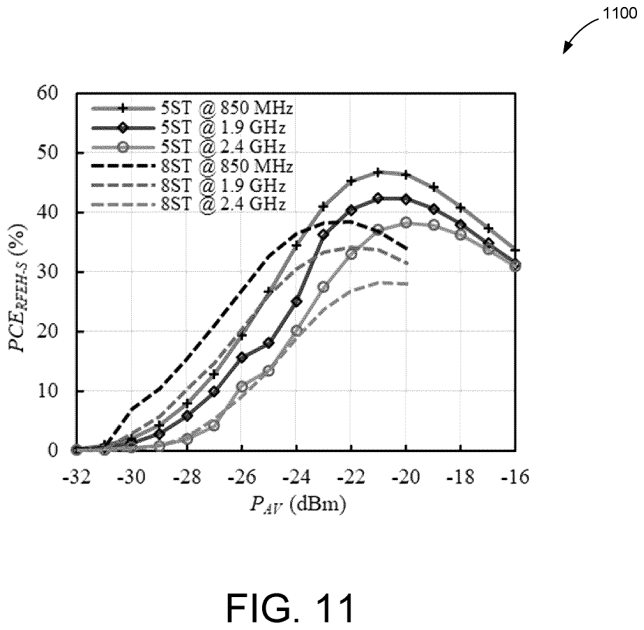

Referring now to FIG. 11, in order to evaluate the performance of the proposed rectifiers (e.g., rectifiers 106₁, 106₂, . . . , 106_{N} of FIG. 1A), a performance analysis was performed at three different frequencies (F1, F2 and F3) and with two different numbers of stages in the rectifiers (namely five (5) and eight (8)), and with different loading resistors (i.e., 450 ko and 1.5 MΩ, respectively). The power conversion efficiency (PCE_{RFEH-S}, as per equation (4) above) of the proposed rectifiers was measured over a wide range of RF input power (e.g., from about −32 dBm to about −16 dBm). As illustrated by plot 1100 of FIG. 11, the proposed rectifiers present high sensitivity and operate efficiently at low power levels (i.e., power levels below about −25 dBm). For example, in one embodiment, for the five-stage rectifier, a peak efficiency of around 46.6% was obtained when generating 1.32 V under a −21 dBm available input power at 850 MHz with a 450 kΩ load resistor. On the other hand, a peak efficiency of around 38.5% was achieved for the eight-stage rectifier at 850 MHz and −22 dBm input power with a 1.5 Mn load resistor. For both rectifiers, the best performance was obtained at the lowest tested frequency of 850 MHz. It is believed that the main reason for this observation is the parasitic capacitance of rectifiers, which load the matching network (e.g., any given one of matching networks 104₁, 104₂, . . . , 104_{N} of FIG. 1A) with a lower impedance at higher frequencies, which combines with a better performance of the matching network at the lowest frequency. The parasitic capacitances (e.g., PCB, wire bonds, metal tracks, and backplate of the input capacitors), the input coupling capacitors (C_{IN}), and the gate capacitance of N(P)MOS transistors (C_{GN(P)}) contribute as input capacitance of the rectifier (C_{REC}) as follows:

$${C}_{REC} \approx N ( {C}_{GN} + {C}_{GP} ) + {C}_{PAR} \qquad ( 7 )$$

where C_{PAR} is the total parasitic capacitance from the RF inputs. Also, for the eight-stage rectifier, the PCE_{RFEH-S} is better for lower input powers (e.g., between about −32 dBm and about −23 dBm) when the five-stage rectifier performs better at higher input powers (e.g., from about −22 dBm and about −16 dBm) (see FIG. 11). Also, the sensitivity of −31 dBm for 1 V was measured with a load impedance of 100 MΩ for an eight-stage rectifier.

The overall efficiency of the proposed multiband RFEH can be obtained from equation (4) as follows:

$$\begin{matrix}P C {E}_{RFEH - M} & = \frac{{P}_{OUT}}{\text{?} {P}_{AV}} = \\ & = ( P E {E}_{MN - M} \times P C {E}_{MN - M} \times P C {E}_{REC - M} ) \\ & = \frac{{V}_{OUT}^{2}}{{R}_{L} \times \text{?} {P}_{AV}}\end{matrix} \qquad ( 8 )$$

where PCE_{RFEH-M} is the overall efficiency of the proposed multiband RFEH (see FIGS. 4A and 4B and FIG. 10). [symbol] P_{AV} is the available input power from multiband frequencies (F1, F2 and F3), PEE_{MN-M} is the power extraction efficiency of the matching networks, PCE_{M}N-Mis the power conversion efficiency of the matching networks, and the PCE_{REC-M} is the power conversion efficiency of the proposed rectifiers depends on availability (see FIGS. 4A and 4B and FIG. 10). Besides, there is some loss contribution with the diode summation scheme (P_{Loss,SUM-D}) as follows:

$${P}_{Loss , SUM - D} = {P}_{Leak - D} + {P}_{Cond - D} \qquad ( 9 )$$

where P_{Cond-D} represents conduction losses related to the voltage drop on the conducting diode in forwarding bias and P_{Leak-D} represents leakage losses on the reversely biased diode. In the proposed design for the diode summation scheme, the sizing of diode-connected transistors was chosen as a trade-off point between conduction losses and leakage losses. For this, the width (W) of the diode-connected transistors (D1, D2, and D3 in FIG. 10) were increased to 50 μm, to increase the current capability of the diodes. Therefore, the forward voltage drops (V_{FWD}) was minimized. On the other hand, by increasing W, the leakage current (I_{LEAK}) also increases (see FIG. 10).

$${V}_{FWD} ∝ \frac{W}{L} \qquad ( 10 )$$

$${I}_{LEAK} ∝ \frac{W}{L} \qquad ( 11 )$$

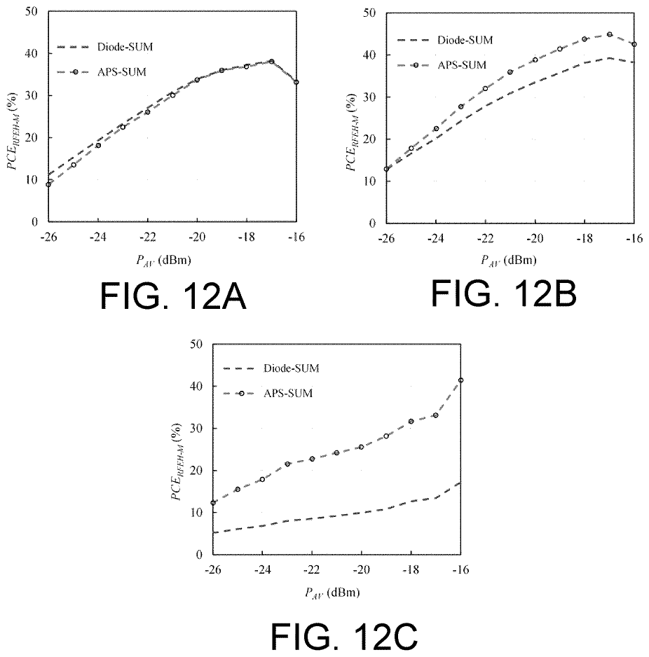

For the power summation unit proposed herein (i.e., APS or AP-SUM), the loss contribution (P_{Loss-APS}) is the total power consumption of the power summation unit (reference 108 in FIG. 4A). FIGS. 12A, 12B, and 12C present the measured PCE of the proposed multiband RFEH (PCE_{RFEH-M}) with two different summation schemes (AP-SUM and Diode-SUM) for three different conditions. The load was varied from 0.2 MΩ to 5 MΩ to find the peak efficiency for each input power when all frequencies were available (normal condition, FIG. 12A). The peak efficiency (as per equation (8)) of the proposed multiband RFEH is around 38% at −17 dBm input power and 500 kΩ load for both summation schemes. On the other hand, the minimum efficiency was obtained at −26 dBm at 2.7 MΩ. The PCE_{RFEH-M} (as per equation (8)) is about 11.2 and 8.8% for both Diode and APS summation schemes, respectively. In this condition, both schemes are working with approximately the same performance. There are only slight differences in PCE_{RFEH-M} in very low input power, between about −23 dBm and about −26 dBm and between about 1% and about 2.5%. This difference is because of the contribution of the power consumption of APS. In a second situation, when two rectifiers are available, frequencies F1 and F2 are considered to be available (see FIG. 4A and FIG. 10). Thus, REC3 will be off (see FIG. 10), and a peak efficiency of 44.8% and 39.2% at −17 dBm is achieved for the proposed APS summation and conventional diode summation network, respectively (see FIG. 12B). The worst condition is when only one frequency is available (third situation) assuming at least one frequency is available. As can be observed from FIG. 12C, there is a significant difference between the proposed APS scheme and the diode-based scheme. The peak efficiency (given by equation (8)) of the diode summation scheme is found at −16 dBm with PCE_{RFEH-M} of about 16% while it is around 41% for the proposed APS summation. In one embodiment, the results prove that the proposed APS summation network may improve performance, while maintaining a high measured PCE_{RFEH-M} (>20%) for P_{AV} ranging from about −23 dBm to about −16 dBm.

Table 1 below summarises the performance of the proposed multiband RFEH (reference 100 in FIG. 1A) and compares it with state-of-art works. The experimental results show the highest sensitivity (−31 dBm at 1 V) among existing works. Furthermore, 46.8% and 44% peak efficiency is achieved at −21 and −17 dBm for single RFEH and multiband RFEH, respectively, exceeding the highest efficiency compared with recent works. Moreover, the proposed RFEH 100 introduces an automated power summation network compared with other works using the conventional diode summation scheme.

TABLE 1
Performance Summary and Comparison with conventional techniques

| | | 2015 | 2015 | 2018 | 2020 | 2013 |
|---|---|---|---|---|---|---|
| | APS | IMS | MTT | MTT | IES | TCAS-I |
| Technology | 65 nm | 90 nm | 65 nm | 180 nm | 130 nm | 130 nm |
| Topology | Cross- | Voltage | Transmission | Transmission | Transmission | Voltage |
| for rectifier | coupled | doubler | line and | line | line and | doubler |
| | (dynamic and | | diode | and diode | diode | |
| | static VT | | | | | |
| | compensation) | | | | | |
| Frequency | 850 MHz | 539 MHz | 900 MHz | 900 MHz | 1.7 GHz | 900 MHz |
| | 1900 MHz | 738 MHz | 1800 MHz | 1.75 GHz | 1.8 GHz | & 2 GHz |
| | 2.4 GHz | | UMTS | 2.45 GHz | 2.1 GHz | |
| | | | 2.4 GHz | | 2 . . . 7 GHz | |
| Tech. & | Automated | Diode | Sum of DC | Diode | Diode | * |
| topology for | with Switch | | output | | | |
| multiband | control | | Current | | | |
| Sensitivity | −31 dBm | −18 dBm | −17.1 dBm | −22 dBm | −3 dBm @ | −19.3 |
| @ V_{OUT} & | @ | @ 1 V & | @ 0.9 & 11 kΩ | @ 1V & | 1 V & NA | dBm |
| R_{L} | 1 V & 100 MΩ | NA | | NA | | @ NA |
| Peak | 46.8% @ −21 | 26% @ | NA | NA | NA | 9.1% * @ |
| PCE_{RFEH-S} | dBm & 450 | −18 dBm & | | | | −19 dBm |
| & | kΩ | NA | | | | & |
| Load | | | | | | 1 MΩ |
| Peak | 44% @ | 34.5% @ | 15% @ | 25% @ | 43% @ | NA |
| PCE_{RFEH-M} | −17 dBm | −2 dBm | −20 dBm | −5 & 0 | −11 dBm | |
| & | & | & | & | dBm | & | |
| Load | Resistor | Resistor | NA | & | Resistor | |
| | 500 kΩ | 147 kΩ | | PMU | 1 | Ω |

* Two separated bands without power summation
IMS: International Microwave Symposium
MTT: IEEE Transactions on Microwave Theory and Techniques
IES: IEEE Transactions on Industrial Electronics
TCAS-I: IEEE Transactions on Circuits and Systems I

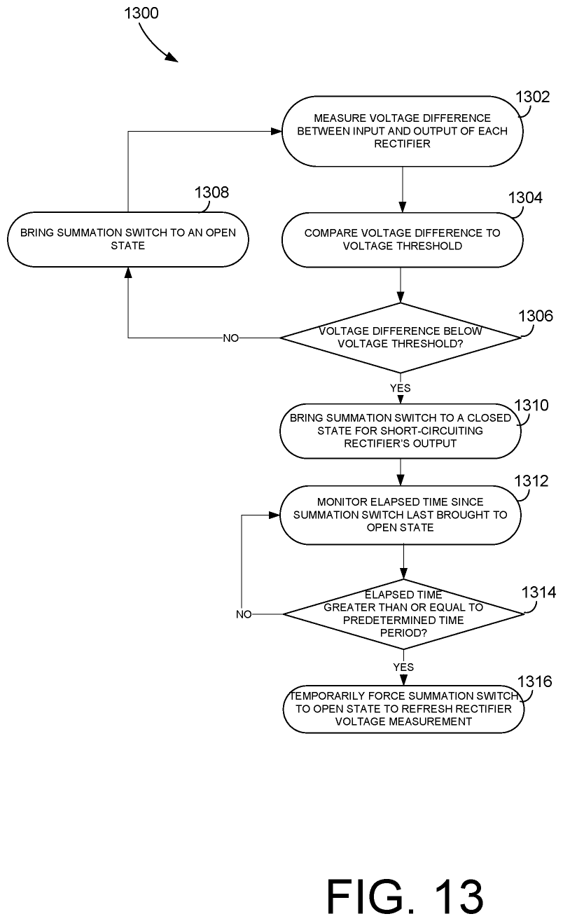

Referring now to FIG. 13, a method 1300 for operating an RFEH, such as the RFEH of FIG. 1A, will now be described, in accordance with one embodiment. The method 1300 is illustratively performed by the power summation unit (reference 108 in FIG. 1A). The voltage difference between an input and an output of each rectifier of the RFEH (reference 100 in FIG. 1A) is measured (step 1302) and compared (step 1304) to a voltage threshold (e.g., using each comparator as in 404₁, 404₂, 404₃, . . . ). At step 1306, it is determined whether the voltage difference is below the voltage threshold. If this is not the case, the corresponding summation switch (connected between the rectifier's input and output nodes) is brought to an open state (step 1308). Otherwise, if the voltage difference is below the voltage threshold, the corresponding summation switch is brought to a closed state for short-circuiting the rectifier's output (step 1310). The elapsed time since the summation switch was last brought to an open state is then monitored (step 1312) and it is then assessed (step 1314) whether the elapsed time is greater than or equal to a predetermined time period (i.e., whether a refresh time has elapsed). If it is not the case, the method 1300 flows back to step 1312, which is then repeated.

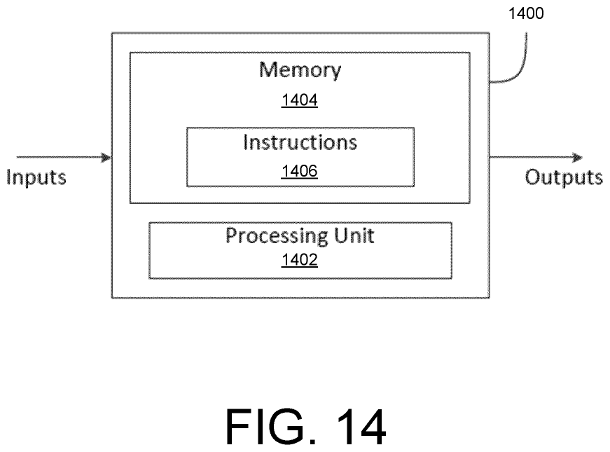

Otherwise, the summation switch is temporarily forced to an open state (step 1316) to refresh the rectifier voltage measurement. Steps 1312, 1314, and 1316 may be performed using the pulse generator (reference 412 in FIG. 4A), in the manner described herein above. FIG. 14 is a schematic diagram of computing device 1400, which may be used to implement the method 1300 of FIG. 13. For example, one or more components of the power summation unit 108 may be implemented using the computing device 1400. The computing device 1400 comprises a processing unit 1402 and a memory 1404 which has stored therein computer-executable instructions 1406. The processing unit 1402 may comprise any suitable devices configured to implement the functionality of the method 1300 such that instructions 1406, when executed by the computing device 1400 or other programmable apparatus, may cause the functions/acts/steps performed by method 1300 as described herein to be executed. The processing unit 1402 may comprise, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 1404 may comprise any suitable known or other machine-readable storage medium. The memory 1404 may comprise non-transitory computer readable storage medium, for example, but not limited to, an electronic, magnetic, optical, electromagnetic, infrared, or semiconductor system, apparatus, or device, or any suitable combination of the foregoing. The memory 1404 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1404 may comprise any storage means (e.g., devices) suitable for retrievably storing machine-readable instructions 1406 executable by the processing unit 1402.

In one embodiment, the methods and systems proposed herein may allow to achieve improved power conversion efficiency (PCE) at ultra-low input power. This may in turn allow to increase system availability by harvesting energy from multiple frequency bands simultaneously. Therefore, in some embodiments, the proposed harvester may maximize the harvested power and conversion efficiency and improve the RFEH system's availability and sensitivity.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A radio frequency energy harvester comprising:
at least one antenna configured to receive, from a radio frequency (RF) energy source, RF signals in a plurality of frequency bands, and to convert the RF signals into alternating current (AC) voltage;
a plurality of multi-stage rectifiers each configured to operate at a respective one of the plurality of frequency bands, each rectifier configured to receive the AC voltage from the at least one antenna and to convert the AC voltage to direct current (DC) voltage; and
at least one power summation unit connected to the plurality of rectifiers and configured to generate a combined DC output voltage based on an output of the plurality of rectifiers, the at least one power summation unit comprising:
a plurality of switching devices, each respective switching device connected to a respective rectifier, each respective switching device configured to be actuated between an open state in which the output of the respective rectifier is open-circuited to form part of the combined DC output voltage and a closed state in which the output of the respective rectifier is short-circuited to be omitted from the combined DC output voltage; and
a plurality of comparators, each respective comparator connected to the respective switching device and to the respective rectifier and configured to:
measure a voltage difference between an input and the output of the respective rectifier;
compare the voltage difference to a voltage threshold;
when the voltage difference is below the voltage threshold, cause the respective switching device to be actuated to the closed state; and
when the voltage difference is greater than or equal to the voltage threshold, cause the respective switching device to be actuated to the open state.

2. The radio frequency energy harvester of claim 1, wherein the at least one power summation unit further comprises transmission gates connected between the respective comparator and the respective switching device, and a pulse generator connected to the transmission gates, the pulse generator configured to, for each respective rectifier:
monitor an elapsed time since the respective switching device was last brought to the open state;
determine that the elapsed time is greater than or equal to a first predetermined time period; and
output a pulse signal to the transmission gates to force the respective switching device to the open state for a second predetermined time period.

3. The radio frequency energy harvester of claim 2, wherein the pulse generator comprises a multi-stage current-starved ring oscillator.

4. The radio frequency energy harvester of claim 1, wherein each comparator is a hysteresis comparator.

5. The radio frequency energy harvester of claim 1, further comprising at least one energy storage device configured to store the combined DC output voltage therein.

6. The radio frequency energy harvester of claim 1, further comprising at least one matching network configured to perform impedance matching between the at least one antenna and the plurality of rectifiers.

7. The radio frequency energy harvester of claim 6, wherein the at least one matching network comprises multiple matching networks having a differential L-network topology.

8. The radio frequency energy harvester of claim 6, wherein the at least one matching network comprises multiple matching networks having a Pi-MN topology.

9. The radio frequency energy harvester of claim 6, wherein the at least one matching network comprises a dual-band matching network.

10. The radio frequency energy harvester of claim 6, wherein the at least one matching network comprises a wide-band matching network.

11. The radio frequency energy harvester of claim 1, wherein the at least one antenna is configured to receive the RF signals at 850 MHz, 1900 MHz, and 2.4 GHz.

12. The radio frequency energy harvester of claim 1, wherein the at least one antenna is a wide-band E-shape linear polarization antenna.

13. The radio frequency energy harvester of claim 1, wherein the at least one antenna is wide-band circular polarization antenna.

14. A power summation unit for a radio frequency energy harvester (RFEH) comprising a plurality of rectifiers, each rectifier configured to convert radio frequency (RF) signals received at an antenna of the RFEH to direct current (DC) voltage, the power summation unit comprising:
a plurality of switching devices, each respective switching device connected to a respective rectifier, each respective switching device configured to be actuated between an open state in which an output of the respective rectifier is open-circuited to form part of a combined DC output voltage and a closed state in which the output of the respective rectifier is short-circuited to be omitted from the combined DC output voltage; and
a plurality of comparators, each respective comparator connected to the respective switching device and to the respective rectifier and configured to:
measure a voltage difference between an input and the output of the respective rectifier;
compare the voltage difference to a voltage threshold;
when the voltage difference is below the voltage threshold, cause the respective switching device to be actuated to the closed state; and
when the measured voltage is greater than or equal to the voltage threshold, cause the respective switching device to be actuated to the open state.

15. The power summation unit of claim 14, further comprising transmission gates connected between the respective comparator and the respective switching device, and a pulse generator connected to the transmission gates, the pulse generator configured to, for each rectifier:
monitor an elapsed time since the switching device was last brought to the open state;
determine that the elapsed time is greater than or equal to a first predetermined time period; and
output a pulse signal to the transmission gates to force the switching device to the open state for a second predetermined time period.

16. The power summation unit of claim 15, wherein the pulse generator comprises a multi-stage current-starved ring oscillator.

17. The power summation unit of claim 14, wherein each comparator is a hysteresis comparator.

18. A method for operating a radio frequency energy harvester (RFEH), the method comprising:
for each rectifier of a plurality of multi-stage rectifiers of the RFEH, each rectifier configured to convert radio frequency (RF) signals received at an antenna of the RFEH to a direct current (DC) voltage, and each rectifier having a switching device connected thereto, the switching device configured to be actuated between an open state in which an output of the rectifier is open-circuited to form part of a combined DC output voltage and a closed state in which the output of the rectifier is short-circuited to be omitted from the combined DC output voltage:
measuring a voltage difference between the input and the output of the rectifier;
comparing the voltage difference to a voltage threshold;
when the voltage difference is below the voltage threshold, causing the switching device to be actuated to the closed state; and
when the voltage difference is greater than or equal to the voltage threshold, causing the switching device to be actuated to the open state.

19. The method of claim 18, further comprising, for each rectifier:
monitoring an elapsed time since the switching device was last brought to the open state;
determining that the elapsed time is greater than or equal to a first predetermined time period; and
forcing the switching device to the open state for a second predetermined time period.

20. The method of claim 18, further comprising storing the combined DC output voltage in at least one energy storage device.
